(19) United States
(12) Patent Application Publication
(10) Pub. No.: US 2010/0128957 A1
(43) Pub. Date: May 27, 2010

(54) BONE DISEASE EVALUATING SYSTEM

(75) Inventor: Yuko Shinden, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Hino-shi, Tokyo (JP)

(21) Appl. No.: 12/594,974

(22) PCT Filed: Apr. 8, 2008
(86) PCT No.: PCT/JP2008/056923

§ 371 Date: Oct. 7, 2009

(30) Foreign Application Priority Data
Apr. 12, 2007 (JP) 2007-105070

(51) Int. Cl. G06K 9/00

(52) U.S. Cl. 382/132

(57) ABSTRACT

A bone disease evaluating system comprising a radiation source for emitting radiation toward an image subject including bones, a detector for detecting a radiation phase contrast image showing the phase contrast of radiation emitted from the radiation source and transmitted through the bones, a joint recognizing section for recognizing a joint of the bones from the phase contrast image, and a profile obtaining section for obtaining a shape profile showing the change of shape of the joint from the recognized joint and a frequency analyzing section for performing frequency analysis of the obtained shape profile and an index calculating section for calculating an index concerning a disease of the joint on the basis of the result of the frequency analysis.

### TECHNICAL FIELD

The present invention relates to a bone disease evaluating system and in particular, a bone disease evaluating system to evaluate extent of the bone disease.

### BACKGROUND ART

Currently, early detection of bone erosion and bone spur, which are types of bone disease, is anticipated. Bone erosion is a disease caused due to erosion of cartilage or bone by proliferated synovial membrane and there are symptoms such as the surface of the bone changing to a moth-eaten pattern or scaly pattern. The symptoms of bone spur include bone proliferating from a surface of the joint and the surface of the bone changing to a spiny pattern. Since such symptoms appear on the surface of the bone, it can be conceived to apply a diagnostic device, as shown in Patent Document 1, where an area of interest is set on a desired joint of bone and the joint of the bone is quantitatively evaluated, for diagnosis of the above described bone diseases.

### DISCLOSURE OF THE INVENTION

### Problems to be Solved by the Invention

However, with the diagnostic device described in Patent Document 1, it was difficult to evaluate the extent of the above described bone disease with high accuracy.

Therefore, an object of the present invention is to enable high accuracy of quantitative diagnosis to measure extent of bone disease such as bone erosion and bone spur.

### Means for Solving the Problem

According to the invention described in claim 1, there is provided a bone disease evaluating system comprising:

a radiation source to emit radiation;

a detector to detect a phase contrast image of the radiation emitted from the radiation source to an image subject including a bone and transmitted through the bone;

a joint recognizing section to recognize a joint section of the bone from the phase contrast image;

a profile obtaining section to obtain a shape profile showing a change in shape of the joint section from the joint section of the bone recognized by the joint recognizing section;

a frequency analyzing section to perform frequency analysis on the shape profile obtained by the profile obtaining section; and

an index calculating section to calculate an index concerning a disease of the joint section based on the analysis result of the frequency analyzing section.

According to the invention described in claim 2, there is provided the bone disease evaluating system of claim 1, wherein the index calculating section compares the calculated index presently calculated in the index calculating section with a previously set threshold value.

According to the invention described in claim 3, there is provided the bone disease evaluating system of claim 1 or 2, further comprising:

a calculated index storage section to store the calculated index calculated by the index calculating section, wherein

the index calculating section compares the calculated index presently calculated by the index calculating section with a past calculated index stored in the calculated index storage section.

According to the invention described in claim 4, there is provided the bone disease evaluating system of any one of claims 1 to 3, further comprising:

a healthy subject database storage section to compile and store a database of an index of healthy subject of each age group and sex based on an analysis result of frequency analysis on a plurality of healthy subjects of different age group and sex, wherein

the index calculating section compares the calculated index presently calculated by the index calculating section with the index in the database of the database storage section with a same age group and sex as a subject who is the object of the calculated index.

According to the invention described in claim 5, there is provided the bone disease evaluating system of any one of claims 1 to 4, wherein the index calculating section calculates an integral value of an analysis result of the frequency analyzing section within a previously set frequency range as the index.

### ADVANTAGEOUS EFFECT OF THE INVENTION

According to the present invention, since a shape profile showing change in shape of a joint section of a bone is obtained by a phase contrast image with higher sharpness than an absorption contrast image, disease such as bone erosion or bone spur are reflected more easily on the shape profile. When frequency analysis is performed on the shape profile, a result of the analysis clearly shows the extent of the disease such as bone erosion or bone spur. When an index concerning the disease of the joint section is calculated based on the analysis result of the frequency analyzing section, the above described disease can be diagnosed quantitatively. With this, the diagnosis accuracy of quantitative disease can be increased more than before.

### BRIEF DESCRIPTION OF THE DRAWINGS

FIG. 1 is a diagram showing a structure of a main section of a bone disease evaluating system of the present embodiment;

FIG. 2 is a side elevation view showing a structure of a main section of a radiation image imaging apparatus of the present embodiment;

FIG. 3 is a schematic view showing an inner structure of the radiation image imaging apparatus of the present embodiment;

FIG. 4 is a perspective view showing a detector provided in the radiation image imaging apparatus of the present embodiment;

FIG. 5 is a plan view when a subject places a back of a left hand upward on a hand holding section of the present embodiment;

FIG. 6 is a block diagram showing a structure of control of the radiation image imaging apparatus of the present embodiment;

FIG. 7 is a diagram explaining an outline of phase contrast imaging of the present embodiment;

FIG. 8 is a diagram explaining a phase contrast effect;

FIG. 9 is a block diagram showing a structure of control of an image processing apparatus of the present embodiment;

FIG. 10A is a diagram showing an example of processing on a phase contrast image obtained by the radiation image imaging apparatus of the present embodiment and an explanatory diagram showing an example of the phase contrast image;

FIG. 10B is a diagram showing an example of processing on a phase contrast image obtained by the radiation image imaging apparatus of the present embodiment and an explanatory diagram showing a sequence of shape recognition processing;

FIG. 11A is a diagram showing an example of processing when a shape profile of an evaluation target bone is obtained in the present embodiment and an explanatory diagram showing a sequence of obtaining a profile;

FIG. 11B is a diagram showing an example of processing when a shape profile of an evaluation target bone is obtained in the present embodiment and a graph showing an example of the shape profile;

FIG. 12 compares a calculated index (above described integral value Hf) of five healthy subjects with those of five bone disease patients;

FIG. 13 is a graph showing an example of a result of Fourier transformation performed on a shape profile of a joint obtained from both a bone disease patient and a healthy subject in the present embodiment;

FIG. 14 is a graph showing an example of an obtained area of an index concerning disease of a joint section in the present embodiment; and

FIG. 15 is a flow diagram showing processing of the present embodiment.

### DESCRIPTION OF REFERENCE NUMERALS

1 radiation image imaging apparatus
2 supporting platform
3 supporting base
4 imaging apparatus main body section
5 supporting axis
6 driving device
7 holding member
8 X-ray source (radiation source)
9 power source section
11 detector
12 detector holding section
13 radiation dose detecting section
14 image subject table
22 control device
24 operation device
29 detector identifying section
30 image processing apparatus
31 control section
32 storage section
33 input section
34 communication section
35 image processing section
37 joint recognizing section
38 index calculating section
39 frequency analyzing section
40 profile obtaining section
50 image output apparatus
100 bone disease evaluating system
R area of interest

### BEST MODE FOR CARRYING OUT THE INVENTION

An embodiment of a bone disease evaluating system 100 of the present invention will be described below with reference to the drawings. However, the present invention is not limited to the illustrated examples.

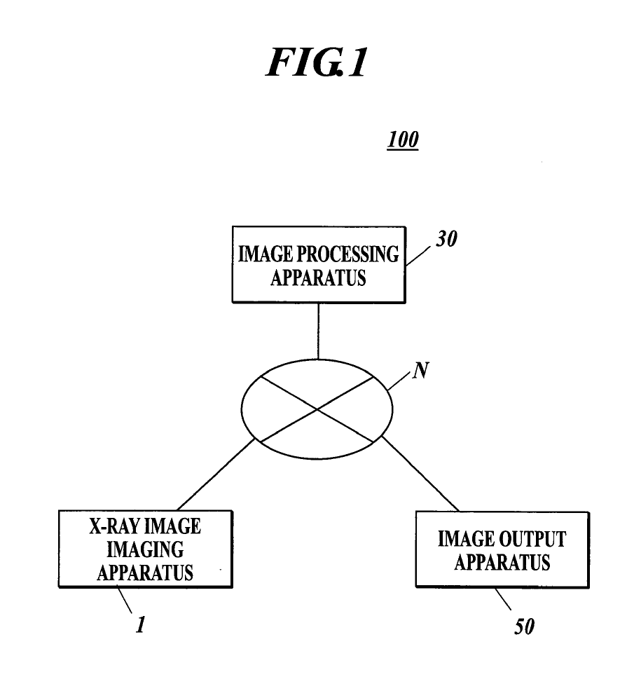

FIG. 1 shows an example of a structure of the bone disease evaluating system 100 of the present embodiment. The bone disease evaluating system 100 of the present embodiment includes a radiation image imaging apparatus 1 for generating an image of the imaging object by exposing X-ray which is radiation, an image processing apparatus 30 for performing image processing, etc. of the image generated by the radiation image imaging apparatus 1, and an image output apparatus 50 for display, output by film, etc. of the image, etc., on which image processing etc., was performed by the image processing apparatus 30, and each apparatus is connected to a communication network N (hereinafter referred to as simply “network”) such as a LAN (Local Area Network), etc., through, for example a switching hub, etc. which is not shown.

Incidentally, the structure of the bone disease evaluating system 100 is not limited to the example described above and for example, there can be a structure where the image processing apparatus 30 and the image output apparatus 50 are integrated and one apparatus performs both the image processing and the output (display, film output or the like) of the image subjected to image processing.

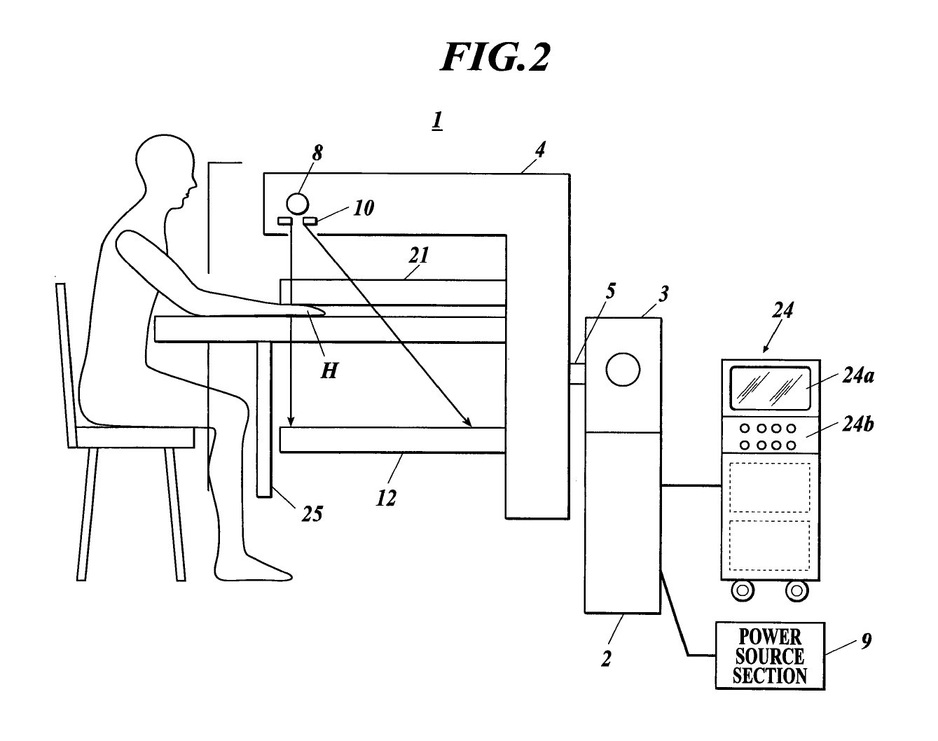

First, the radiation image imaging apparatus 1 is described with reference to FIG. 2 to FIG. 8.

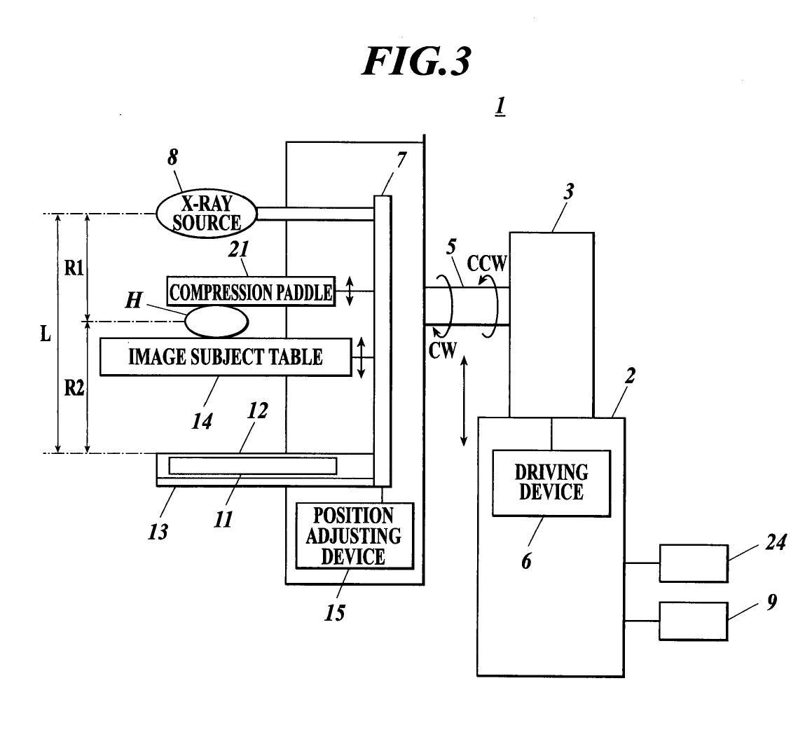

FIG. 2 and FIG. 3 show an example of a structure of the radiation image imaging apparatus 1. The radiation image imaging apparatus 1 is provided with a supporting base 3 which can move up and down freely with respect to a supporting platform 2. An imaging apparatus main body section 4 is supported by the supporting base 3 through a supporting axis 5 so as to be able to rotate freely in a CW direction and CCW direction. A driving device 6 is included in the supporting base 3 to drive the up and down movement of the supporting base and the rotation of the supporting axis 5. The driving device 6 includes a publicly known driving motor etc. which is not shown. The supporting base 3 and the imaging apparatus main body section 4 are to move up and down according to the position of the image subject H. The position of the image subject H can be adjusted to a position where the subject can assume a less tiring posture with his arm placed on a later described image subject table 14.

A holding member 7 is provided along an up and down direction on the imaging apparatus main body section 4. An X-ray source 8 is provided on the upper section of the holding member 7 as a radiation source of the present invention to emit radiation at a lower tube voltage to the image subject H. A power source section 9 to apply tube voltage and tube electric current is connected to the X-ray source 8 through the supporting axis 5, supporting base 3 and imaging apparatus main body section 4. An aperture 10 is provided in the radiation emitting port of the X-ray source 8 to be able to open and close freely for adjusting the radiation exposure field. Also, the focal size of the X-ray source 8 can be changed according to the imaging method described later.

It is preferable that a rotary anode X-ray tube is used as the X-ray source 8. The X-ray is generated in the rotary anode X-ray tube when an electron ray emitted from a cathode collides with an anode. This is incoherent similar to natural light, and is not a parallel light X-ray but a diverging light. When the electron ray continues to hit a fixed area of the anode, the anode is damaged by the generation of heat and therefore, in a commonly used X-ray tube, the anode rotates to prevent drop of life span of the anode. The electron ray collides to the anode at a plane of a certain size and the generated X-ray is emitted from a plane of the anode in the certain size to the image subject H. The size of the plane seen from the emitting direction (image subject direction) is called focus. The focal size D (μm) means, when the focus is a square the length of one side, when the focus is a rectangle or other polygon the length of a long side or a short side, and when the focus is a circle the diameter. Generally, the larger the focal size D is, more radiation dose can be irradiated.

In the present embodiment, a tungsten anode with few low energy components which do not contribute to forming of the radiation image is used as the X-ray tube anode. This is typically used in general medical imaging and enables radiation imaging with a relatively small dose of exposure.

The radiation image imaging apparatus 1 of the present embodiment adjusts the tube voltage so that the energy amount is within the range of 23 key to 30 keV when the radiation image of the hand and finger is obtained and the tube voltage is applied to the X-ray source 8. Here, in the X-ray source 8, it is preferable that the inherent filtration of the IEC 60522-1976 standard is 2.5 mm aluminum equivalent or more, and it is more preferable that the tungsten anode is used to obtain a phase contrast radiation image to be able to calculate an index to show the extent of the disease of the bone joint. It is preferable that the tube voltage applied to the X-ray source 8 is 25 kVp or more and 39 kVp or less. When the tube voltage is too low, the irradiated X-ray is absorbed entirely in the bone of the image subject and the transmitted X-ray dose necessary for measurement cannot be obtained. Also, when the tube voltage is too high, the obtained image subject contrast becomes low and the measurement accuracy decreases.

By setting the tube voltage as described above, image imaging with X-ray at 23 keV to 30 keV can be performed.

As for the X-ray average energy, for example, in a tungsten anode where inherent filtration of the IEC 60522-1976 standard is 2.5 mm aluminum equivalent, X-ray average energy of 23 keV can be obtained at setting of tube voltage 30 kVp and 30 keV can be obtained at 39 kVp setting.

A radiation dose detecting section 13 to perform detection of the irradiated radiation dose with the detector 11 is provided at a bottom of the holding member 7 on the bottom face of the detector holding section 12.

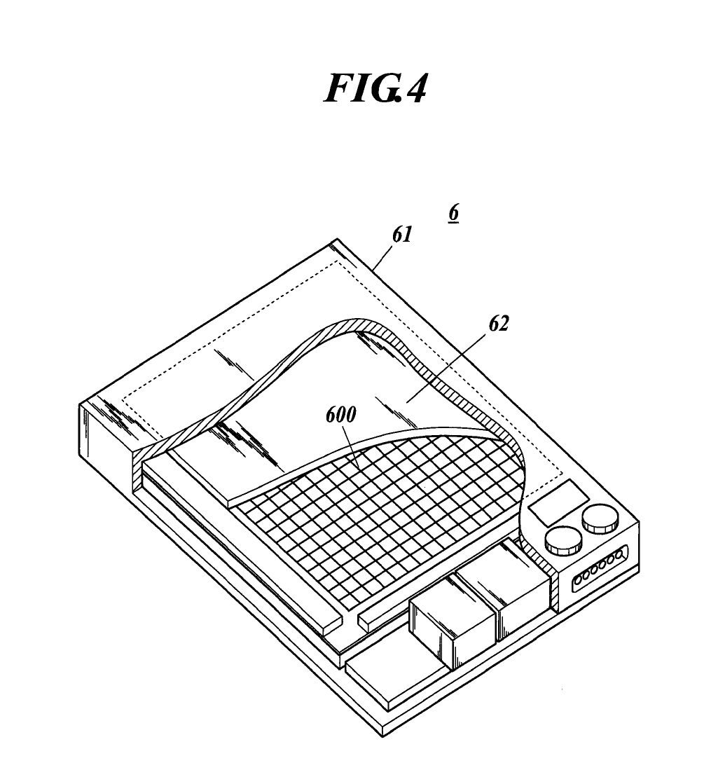

The structure of detector 11 is described with a flat panel detector (FPD) as an example with reference to FIG. 4. FIG. 4 is a perspective view of the detector 11. The detector 11 includes a chassis 61 to protect an inner section and is structured to be portable as a cassette.

An imaging panel 62 to convert irradiated radiation to an electric signal is formed in layers in the inner section of the chassis 61. A light emitting layer (not shown) to perform light emission according to the intensity of the entering radiation is provided on a side of a face irradiated with radiation on the imaging panel 62.

The light emitting layer is generally called a scintillator layer and its main component is, for example, phosphor. Depending on the entering radiation, the light emitting layer outputs electromagnetic waves with a wavelength of 300 nm to 800 nm, in other words, electromagnetic waves (light) mainly of visible light from ultraviolet ray to infrared ray.

A signal detecting section 600 is formed on a face of the light emitting layer opposite of the face on the side where radiation is irradiated. On the signal detecting section 600, a photoelectric converting section is arranged in a matrix shape for converting the electromagnetic wave (light) output from the light emitting layer to electric energy and charging the electric energy to output an image signal based on the charged electric energy. Incidentally, a signal output from one photoelectric converting section is a signal corresponding to one pixel, which is to be the smallest unit which composes the radiation image data. After the signal detecting section 600 extracts charged electric energy as an electric signal by switching and amplifies the electric signal at a predetermined amplification ratio (gain), the signal detecting section 600 converts the electric signal to digital data. In this way, the radiation image data is made by the imaging panel 62.

An image subject table 14 in a flat plate shape is provided between the X-ray source 8 and the detector holding section 12 so that one end is fixed to the holding member 7 to hold from the bottom a hand and fingers of the subject who is the image subject H. The image subject table 14 is connected to the position adjusting device 15 including a motor, etc. to change a position with respect to the holding member 7 in order to adjust magnification ratio (position adjustment in a height direction) when phase contrast imaging is performed.

The image subject table 14 is formed projecting toward the subject side than the other end of the detector holding section 12. A compression paddle 21 to compress and fix the image subject H from above is included in an upper side of the image subject table 14, with one end attached to the holding member 7. The compression paddle 21 can move freely along the holding member 7. Automatic operation or manual operation can be applied to the movement of the compression paddle 21. An end face of the compression paddle 21 on the subject side is positioned protruding slightly to the subject side than the X-ray source 8 and the detector 11 (active image end face) which are positioned in a substantially perpendicular direction. Therefore, it is preferable that the imaging target area (for example, right hand) of the subject is placed in a position to the holding member 7 side than the compression paddle 21, so that image deficiency in the area of interest (image target area) does not occur. Also, it is preferable that the end face of the image subject table 14 is a curved face shape, so that an elderly subject with an average body size can lean his upper half of the body toward the image subject table 14 while sitting on a chair X.

Also, in the present embodiment, a protector 25 is provided on the bottom face of the image subject table 14 extending in a substantially vertical direction so that the subject can take an imaging position without hitting his leg. With this, the subject can take an imaging position without hitting his leg to the detector holding section 12 while sitting in the chair X. Also, this prevents a portion of the body of the patient from being inside an X-ray exposure area and unnecessary exposure can be prevented. Incidentally, the compression paddle and the protector 25 are not essential components, and there can be a structure not using the compression paddle and the protector 25.

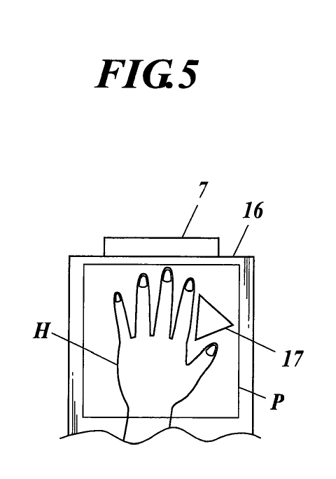

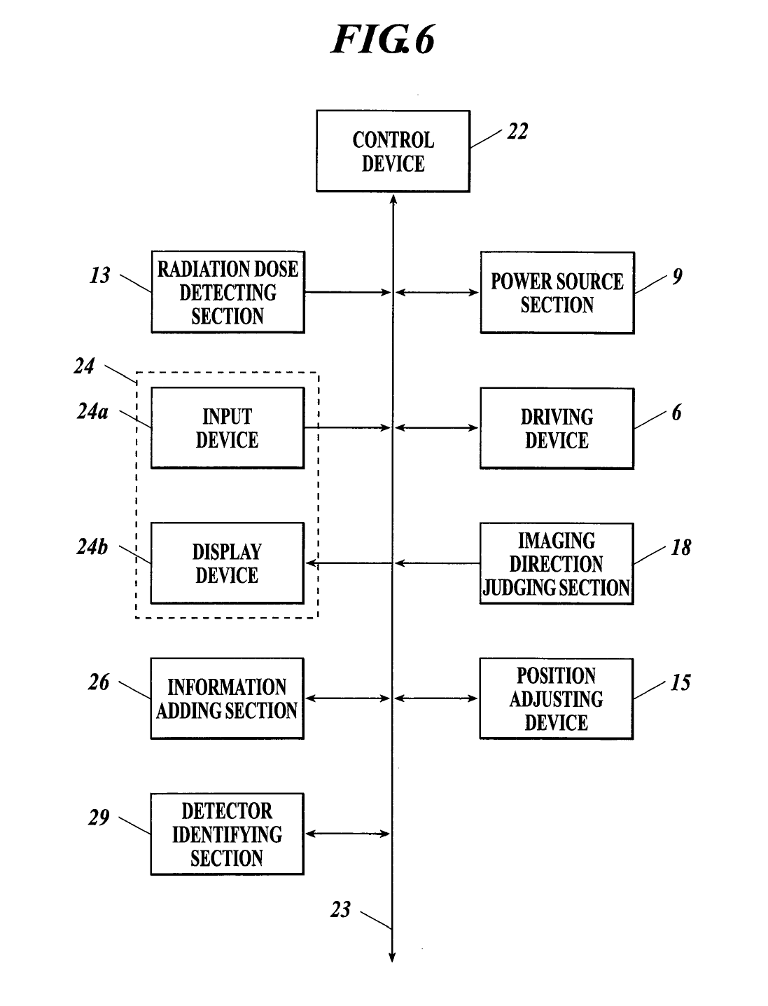

As shown in FIG. 5, a hand holding section 16 to hold a hand and fingers of the subject is included on the image subject table 14 intersecting the radiation exposure path. There is no limit to the size of the hand holding section 16 as long as it is possible to place the hand and fingers of the subject. A triangular magnet 17 is included on the upper face of the hand holding section 16 and the triangular magnet 17 is positioned between a thumb and index finger when the subject places his hand and fingers on the hand holding section 16. The hand holding section 16 includes an imaging direction judging section 18 (see FIG. 6) to detect a location where the triangular magnet 17 is placed to judge the position of the thumb of the subject as imaging direction information.

Here, the exposure area P when the bone joint of the hand is imaged is previously set so that two finger bones with a joint in between are within the area (see FIG. 5).

As shown in FIG. 6, the imaging apparatus main body section 4 includes a control device 22 composed of a CPU (Central Processing Unit), ROM (Read Only Memory) and Random Access Memory (RAM). The radiation dose detecting section 13, power source section 9, driving device 6, position adjusting device 15, information adding section 26, imaging direction judging section 18 and detector identifying section 29 are connected to the control device 22 through a bus 23. Also, an operation device 24 is connected to the control device 22, and the operation device 24 includes an input device 24a including a keyboard or touch panel (not shown) to input imaging condition etc., a position adjustment switch to adjust the position of the image subject table 14 and the like and a display device 24b, such as a CRT display, liquid crystal display, or the like. Incidentally, other than the above, the imaging apparatus main body section 4 can be provided with an information obtaining section to obtain patient information, etc. by reading a barcode, etc.

A control program to control each section of the radiation image imaging apparatus 1 and various processing programs are stored in the ROM of the control device 22, and in coordination with the control program and various processing programs, the CPU centrally controls the operation of each section of the radiation image imaging apparatus 1 and performs phase contrast imaging and the CPU functions as an image data generating section to generate image data of the phase contrast image.

For example, based on the detection result by the imaging direction judging section 18 and imaging condition, etc. of the subject, the CPU controls the driving device 6 to move the imaging apparatus main body section 4 up and down to a height suitable to the height, etc. of the subject and to turn the supporting axis to adjust the angle of exposure of radiation. Then, the position of the image subject table 14 is adjusted by the position adjusting device 15 to adjust a magnification factor of the phase contrast imaging. Then, the imaging apparatus main body section 4 performs the imaging processing and with the power source section 9, tube voltage is applied to the X-ray source 8 and the radiation is irradiated to the image subject H, and when the radiation dose input from the radiation dose detecting section 13 reaches a previously set radiation dose, the irradiation of radiation from the X-ray source 8 is stopped with the power source section 9. Also, the irradiation condition of the X-ray can be previously set and the X-ray can be irradiated with such condition.

As described above, the imaging direction information obtained by the imaging direction judging section 18 and the left and right information input from the input device 24a are output to the information adding section 26 through the control device 22. Also, in the present embodiment, patient information concerning the image subject H (imaged subject information), information of when the image was imaged (imaged time information), site information concerning imaged site showing which site of the patient the imaged image subject H is and the like are input from the operation device 24, information obtaining section which is not shown, etc., and the input information is output to the information adding section 26 through the control device 22. Incidentally, when the control device 22 includes a timer function, the control device 22 can automatically obtain the imaged time when the imaging is performed without the imaged time information being input separately and the imaged time can be output to the information adding section 26 as imaged time information added to the image data.

The information adding section 26 links the various information (imaging direction information, left and right information, imaged subject information, imaged time information, site information, etc.) to the image data of the generated phase contrast image as added information. Incidentally, the added information added to the image data by the information adding section 26 is not limited to the above information. For example, patient (imaged subject) ID information, etc. can be added. Also, the information adding section 26 is not limited to adding all of the pieces of information shown as examples here, and a piece of the above information can be added.

The detector identifying section 29 is internally included in the detector holding section 12, and the detector identifying section 29 identifies whether the detector 11 set in the detector holding section 12 is for normal imaging, for phase contrast imaging, or for high magnification phase contrast imaging. Specifically, the detector identifying section 29 identifies by reading an identification mark (concavo-convex section), conducting section, RFID, barcode, etc. provided on the chassis, etc. of the detector 11. Then, the detector identifying section 29, for example compares the detector with the image condition input from the operation device 24 and judges whether or not the detector is suitable for radiation image to be performed and outputs the identification result to the control device 22. When the identification result is not suitable, the control device 22 controls the display device 24b to display a warning. In other words, in the present embodiment, the alarming section of the present embodiment is the display device 24b. Incidentally, the alarming section does not have to perform a visual alarm and can perform an auditory alarm.

Also, the control device 22 controls each section so that normal imaging, phase contrast imaging and high magnification phase contrast imaging are each performed by an imaging switching instruction on the input device 24a.

Here, normal imaging is imaging normally performed where an imaging condition is to bring the image subject H in close contact with the detector 11. In this case, the control device 22 sets the suitable detector to “for normal imaging” so that a detector 11 for normal imaging is equipped.

In phase contrast imaging where a large area of the hand is imaged, the focal size D of the X-ray source 8 is 0.1 mm and the average radiation energy is 26 keV so that phase contrast imaging is performed corresponding to the later described magnification factor M which is 1.5 times to 3 times. Further, in the phase contrast imaging, compared to normal imaging, the ratio of the signal value output from the detector 11 compared to the irradiated dose (ray dose) of the radiation irradiated to the detector 11 is moderately high. This is because since the distance between the X-ray tube and the detector becomes long and the average radiation energy becomes low, the X-ray dose which reaches the detector 11 reduces.

In order to make the ratio of the signal value output from the detector 11 to the ray dose of the irradiated radiation high, the methods conceivable are, to select a detector 11 with a high sensitivity and mount it to the detector holding section 12 or make the amplification ratio (gain) of the signal output from the detector 11 high or a combination thereof. In order to make the sensitivity of the detector 11 high, for example, the photostimulable phosphor sheet stored in the detector 11 or the light emitting layer used in the imaging panel 62 is made to emit light with high brightness even with low radiation dose. Also, in order to make the gain high, for example, the amplification ratio of the electric signal in the signal detecting section 600 is made high, or in a reading device which reads the photostimulable phosphor sheet irradiated with radiation to output irradiation image data, the amplification ratio of the electric signal of the read photostimulable phosphor sheet is made high. Also, the ratio of amplification of the radiation image data output from the detector 11 or the reading device can be made high. In the present embodiment, the control device 22 sets the suitable detector to “for phase contrast imaging” so that a detector 11 for phase contrast imaging with higher sensitivity and higher gain than the detector 11 for normal imaging is mounted. This phase contrast imaging is applied to quantitative diagnosis of osteoporosis. On the other hand, in the high magnification phase contrast imaging which is applied to the quantitative diagnosis of deformation of bone joint for rheumatic disease, the focal size D of the X-ray source 8 is 0.05 mm and the average radiation energy is 23 keV so that phase contrast imaging is performed corresponding to the magnification factor M which is 3 times to 10 times. Further, in the high magnification phase contrast imaging, both sensitivity and gain is higher compared to the phase contrast imaging. In other words, the control device 22 sets the suitable detector to “for high magnification phase contrast imaging” so that the detector 11 for high magnification phase contrast imaging is mounted. This is because in the high magnification phase contrast imaging, the image subject H and the detector 11 are separated more than the phase contrast imaging and the average radiation energy is low.

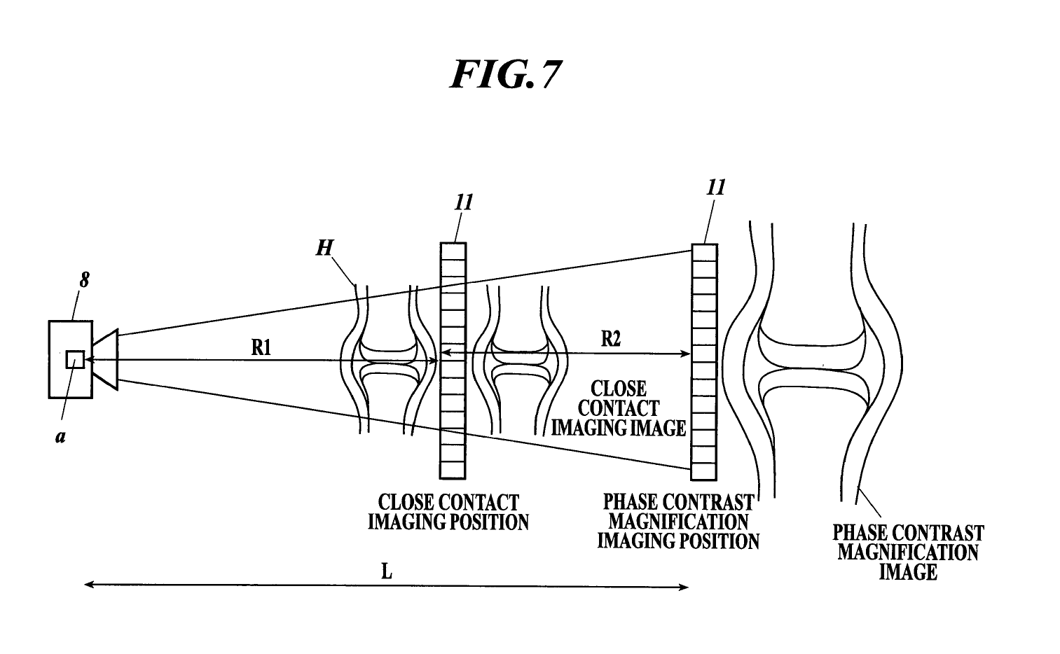

Next, method of phase contrast imaging is described. FIG. 7 is a diagram explaining an outline of phase contrast imaging. As shown in FIG. 7, in a method of normal imaging, the image subject H is placed in a position where the detector 11 is in contact with the image subject H (close contact imaging position shown in FIG. 7). In this case, the X-ray image (latent image) recorded with the detector 11 is substantially the same as life size (same size as the image subject H).

On the other hand, in the phase contrast imaging, a distance is provided between the image subject H and the detector 11 and when an X-ray is irradiated in a cone-beam shape from the X-ray source 8, the latent image of the X-ray image enlarged from life size (hereinafter referred to as enlarged image) is detected with the detector 11.

Here, the magnification factor M with respect to life size of the enlarged image can be calculated by the following equation (1) with a distance from the focal point a of the X-ray source 8 to the image subject H as R1, a distance from the image subject H to the detector 11 as R2, and a distance from the focal point a of the X-ray source 8 to the detector 11 as L (L=R1+R2).

M=L/R1 (1)

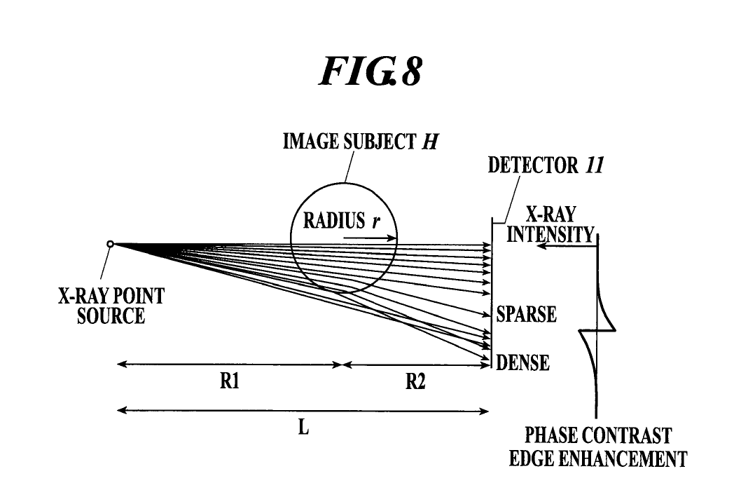

In the phase contrast enlarged image, as shown in FIG. 8, the X-ray refracted by passing the border of the image subject H and the X-ray which did not pass through the image subject H overlaps on the detector 11 and the intensity of the X-ray of the overlapped portion becomes strong. On the other hand, a phenomenon occurs where the X-ray intensity becomes weaker in the portion on the inside of the border of the image subject H, in the amount of the refracted X-ray. Therefore, an edge enhancement action (also called edge effect) where the difference in intensity of X-ray spreads from the border of the image subject H and an X-ray image with high visibility where the border portion is sharply described can be obtained.

When there is a limit to setting the distance L such as inside the imaging room, etc., the distance L can be fixed and the ratio of the distance R1 and R2 can be changed within the fixed distance L to be able to perform imaging at the optimum condition. For example, when it is determined that L=3.0 (m), with respect to this distance L, R1=1.0 (m) and R2=2.0 (m). Considering a size of a general imaging room, the range is to be 0.1≦R1≦2.0, 0.3≦R2≦2.0 and 0.8≦L≦4.0, the range of the magnification factor M is to be 1.5≦M≦10 and the range of the focal point size D is to be 0.005 (mm)≦D≦0.2 (mm), and the optimum distance L, R1 and R2 and the magnification ratio M and focal point size D can be determined empirically or experimentally within the above range while observing the relation to the visibility of the enlarged image. By setting the range of the focal point size D as described above, the X-ray intensity is strong and imaging in a short time is possible, and therefore blur due to movement of the image subject H can be made smaller. Incidentally, a more preferable distance can be set within the range of 0.5≦R1≦1.25, 0.5≦R2≦1.25 and 1.0≦L≦2.5, the range of the magnification factor M is to be 3≦M≦8 and the range of the focal point size D is to be 0.03 (mm)≦D≦0.08 (mm).

The higher the magnification ratio M is, finer image information can be obtained and the quantitative result becomes highly accurate. On the other hand, in high magnification ratio imaging, an X-ray tube with a smaller focal point size is necessary, however, the output becomes low and the imaging time becomes longer, and therefore, blur due to movement of the image subject occurs more easily and the sharpness image quality is lost and analysis with high accuracy cannot be performed, and therefore realistically, the above described range is optimum.

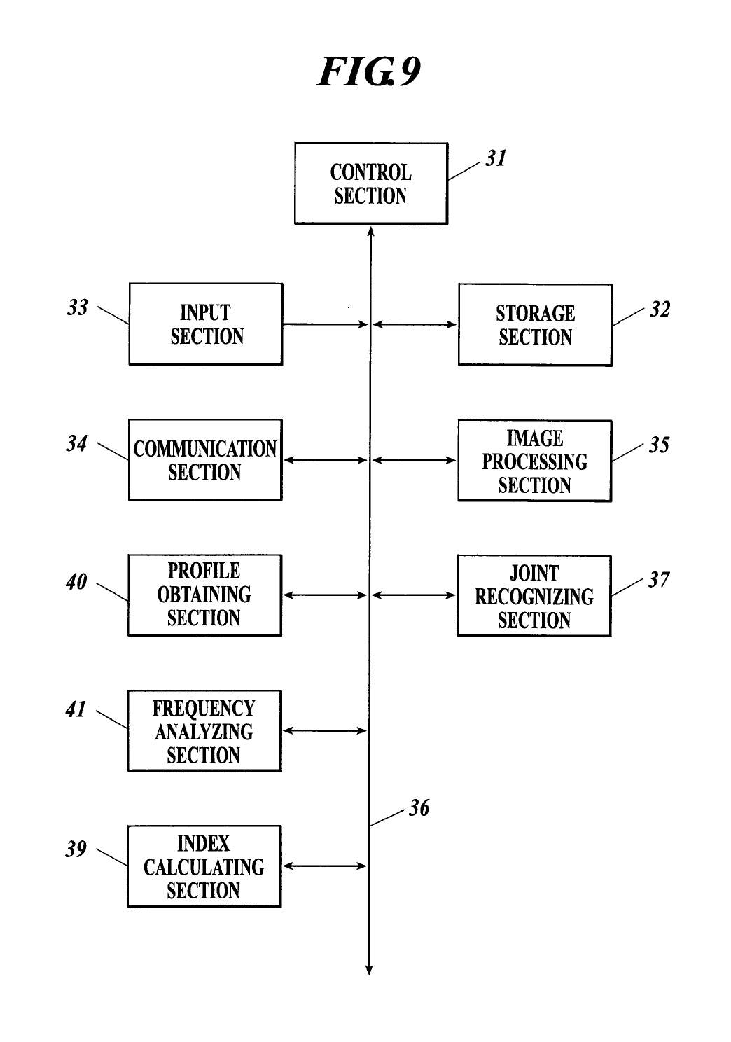

Next, the image processing apparatus 30 of the present embodiment is described with reference to FIG. 9.

The image processing apparatus 30 of the present invention performs image processing on the data of the radiation image generated by the radiation image imaging apparatus 1 and generates an image suitable for diagnosis. As shown in FIG. 9, the image processing apparatus 30 includes, a control section 31, storage section 32, input section 33, communication section 34, image processing section 35, joint recognizing section 37, index calculating section 38, frequency analyzing section 39, profile obtaining section 40 and the like, and each of these sections are connected to each other through a bus 36.

The control section 31 includes a CPU (Central Processing Unit), RAM (Random Access Memory), ROM (Read Only Memory) and the like (all not shown), and according to various programs stored in the ROM or the storage section 32, a predetermined area of the RAM is to be the work area and the CPU centrally controls the general operation of the image processing apparatus 30 by sending control signals to the above described sections and performs various processing such as later described image extracting processing, etc. Incidentally, similar to the control section 31, as for the image processing section 35, joint recognizing section 37 and frequency analyzing section 39 the CPU operates according to various programs.

The storage section 32 fixedly or removably includes a storage medium which is not shown, for example a magnetic or optical storage medium such as a HDD (Hard Disk Drive) optical disk, etc., or semiconductor memory and the like and stores various programs of the image processing apparatus 30 such as image processing program, etc. and various data used when performing the above described processing programs.

Also, in the present embodiment, the image data of the radiation image imaged by the radiation image imaging apparatus 1 and sent to the image processing apparatus 30 is stored in the storage section 32. In the present embodiment, as described above, the image data of the radiation image is sent to the image processing apparatus 30 with the imaging direction information, left and right information, imaged subject information, imaged time information, site information, etc. added as added information by the information adding section 26 of the radiation image imaging apparatus 1 and the storage section 32 stores theses pieces of information in a state added to the image data.

The storage section 32 stores a threshold value to compare with the index (later described) calculated by the index calculating section 38. The threshold value is compared with the index calculated in the index calculating section 38 to determine whether or not the disease occurred in the joint section of the bone and a suitable value is assigned by experiment, simulation, etc.

Also, the storage section 32 stores the calculated index calculated in the index calculating section 38 associated with the identification information of the patient. In other words, the storage section 32 is the calculated index storage section of the present invention. With this, a calculated index history of a same patient is made, and the calculated index presently calculated can be compared with the calculated index calculated in the past and the change of the disease over time in the same patient can also be tracked.

Based on the analysis result of frequency analysis on a plurality of healthy subjects of different age group and sex, the storage section 32 compiles a database of indexes (later described indexes concerning joint disease) of healthy subjects of each age group and sex and stores the database. In other words, the storage section 32 is a database storage section of the present invention. Here, the frequency analysis of healthy subjects is similar to the frequency analysis performed in the later described frequency analyzing section 39 and the presently calculated index can be compared with the index in the database with the same age group and sex as the subject who is the object of the calculated index.

Further, the storage section 32 stores a shape list of the joint section of each bone. With this, the bone imaged in the image data of the radiation image is referred to the shape list so as to be able to identify which joint section of which bone the joint section of the bone in the image data is.

The input section 33 includes a keyboard including, for example, cursor key, number input key, various function keys and the like which are not shown, and a pointing device such as a mouse, and image processing conditions and the like can be input. The input section 33 outputs an instruction signal input by the key operation on the keyboard, the mouse operation, etc. to the control section 31. The operator operates the input section 33 to specify (evaluation target bone specification instruction) the evaluation target bone on which evaluation of the joint section is performed from each bone imaged in the phase contrast image.

The communication section 34 includes a network interface etc., and performs sending and receiving of data to and from radiation image imaging apparatus 1, external devices such as image output apparatus 50 and the like connected to the network N through a switching hub. In other words, through the network N, the communication section 34 receives image data of the radiation image generated by the radiation image imaging apparatus 1 and sends the image data of the image data subjected to image processing to suitable external devices such as image output apparatus 50, etc.

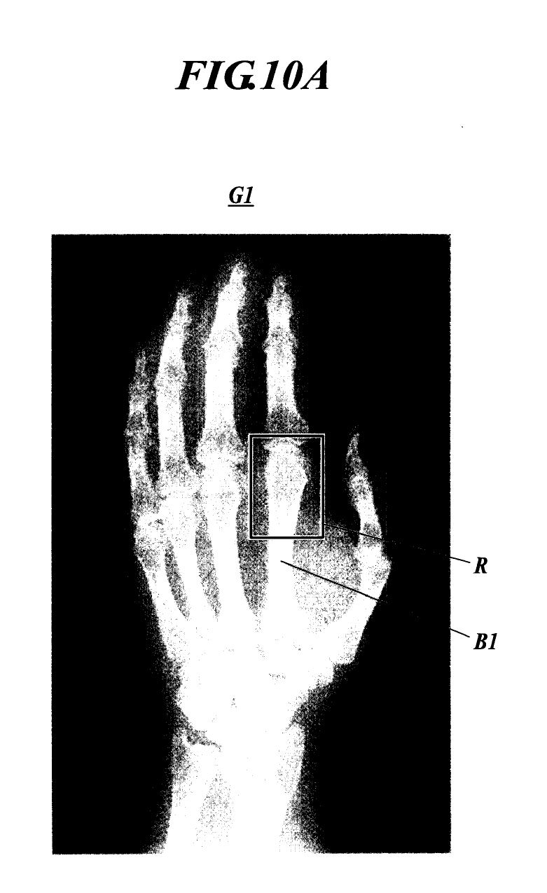

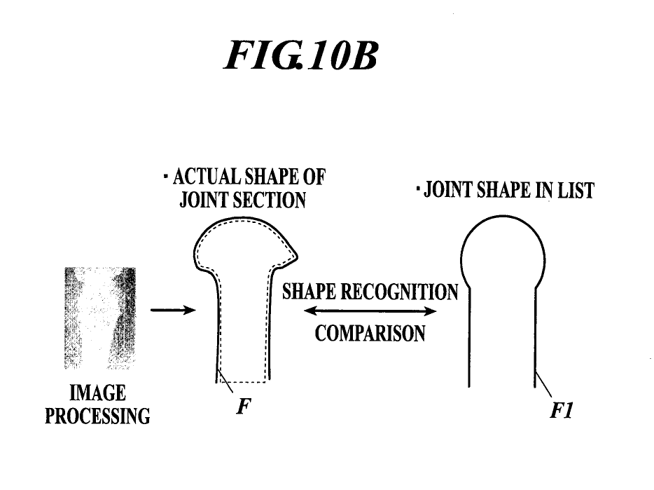

The joint recognizing section 37 recognizes the shape of the joint section of the target bone B1 from the phase contrast image of the evaluation target bone B1. When the operator inputs the evaluation target bone specification instruction in the input section 33, according to the instruction content, the joint recognizing section 37 specifies the evaluation target bone from the bones in the phase contrast image and recognizes the shape of the joint section. Specifically, as shown in FIG. 10A, when the phase contrast image G1 of the hand is obtained, the joint recognizing section 37 sets the interest area R so that the joint section of the evaluation target bone B1 in the image is within the area. Then, as shown in FIG. 10B, the joint recognizing section 37 extracts only the actual shape of the joint section by performing image processing on the image data in the interest area R. The extracted outer shape line F of the joint section is compared with the outer shape line F1 of the joint section in the shape list in the storage section 32 and the joint recognizing section 37 specifies which bone the evaluation target bone B1 is.

Incidentally, various methods of setting the interest area can be contemplated, for example, setting the interest area by specifying a rectangular frame with the input section 33, or automatic setting by performing image analysis on the radiation image. When automatic setting is performed, the setting should be performed so that at least the border of the joint section of the evaluation target bone B1 is within the interest area.

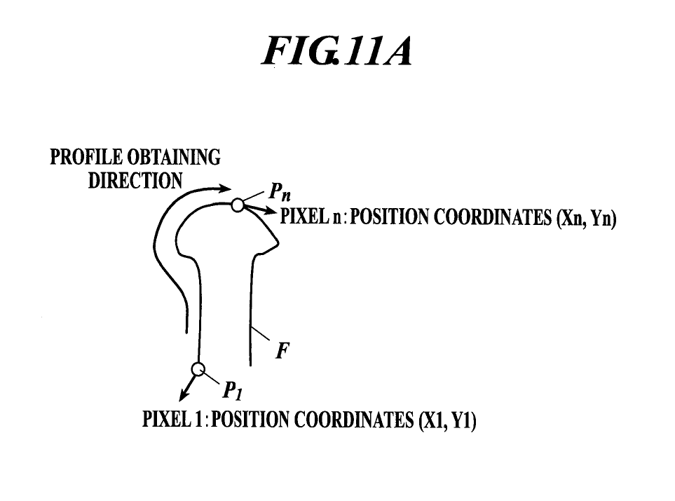

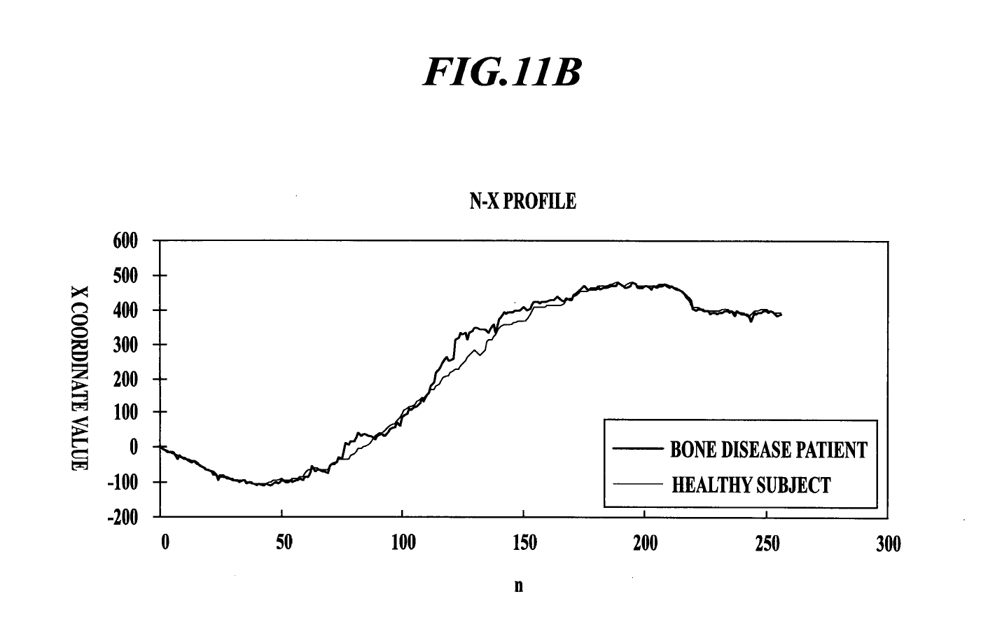

The profile obtaining section 40 obtains a shape profile representing the change of shape of the bone B1 from the outer line F of the bone obtained in the joint recognizing section 37. Specifically, as shown in FIG. 11A, the profile obtaining section 40 starts from a point of pixel P1 which is an end point of the left side of the outer line F of the bone within the interest area R and obtains the X coordinate value and Y coordinate value of each pixel Pn on the outer line F for each predetermined interval in the profile obtaining direction and ends in the right side end point of the outer line F. Then, the profile obtaining section 40 sets the X coordinate and Y coordinate of the starting point (first point) (X1, Y1) to (0,0), the X coordinate and Y coordinate of the n-th point to (Xn, Yn) and forms a shape profile with an n-X profile where the n-th point is the horizontal axis and the X coordinate value is the vertical axis and an n-Y profile where the n-th point is the horizontal axis and the Y coordinate value is the vertical axis. FIG. 11B shows an example of an n-X profile of a bone disease patient and a healthy subject.

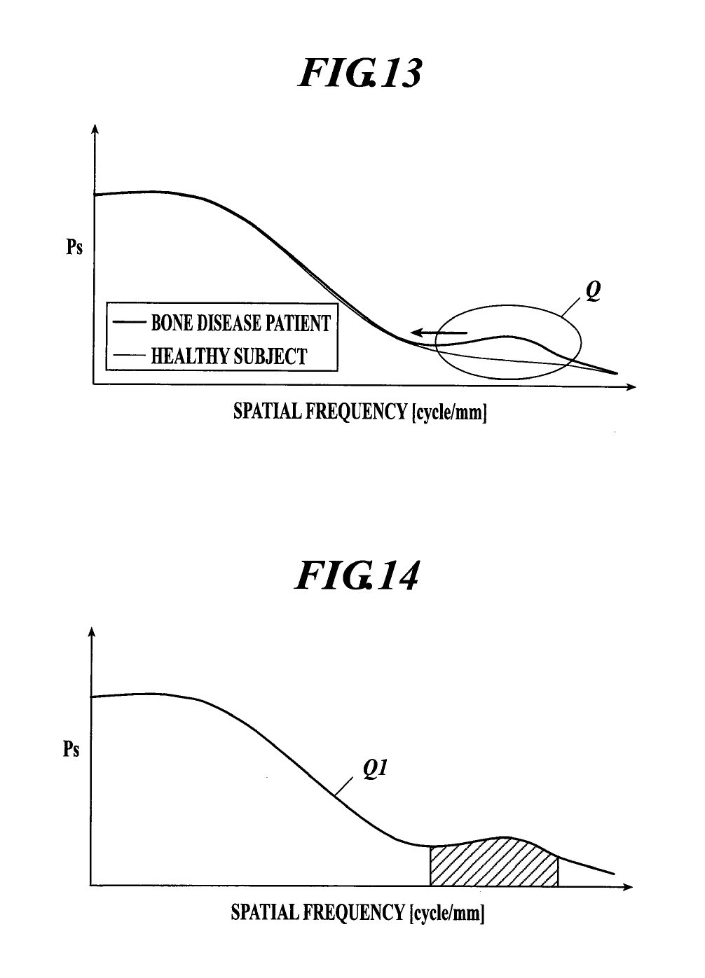

The frequency analyzing section 39 performs frequency analysis on the shape profile obtained by the profile obtaining section 40. As frequency analysis, for example, there are analysis methods such as analysis method by Fourier transformation or analysis method by wavelet transformation. FIG. 13 is a graph showing an example where a shape profile of a joint section of both a bone disease patient and a healthy subject is obtained and the result of performing Fourier transformation on the shape profile. As shown in FIG. 13, in the bone disease patient, the PS (power spectrum) of the area surrounded by the oval Q is higher than the healthy subject. As described above, by performing frequency analysis on the shape profile of the joint section, the difference between a healthy subject and a patient is expressed in the analysis result.

Incidentally, as described above, the frequency analysis performed in the frequency analyzing section 39 is applied when an index to be compiled as the database and stored in the storage section 32 is calculated.

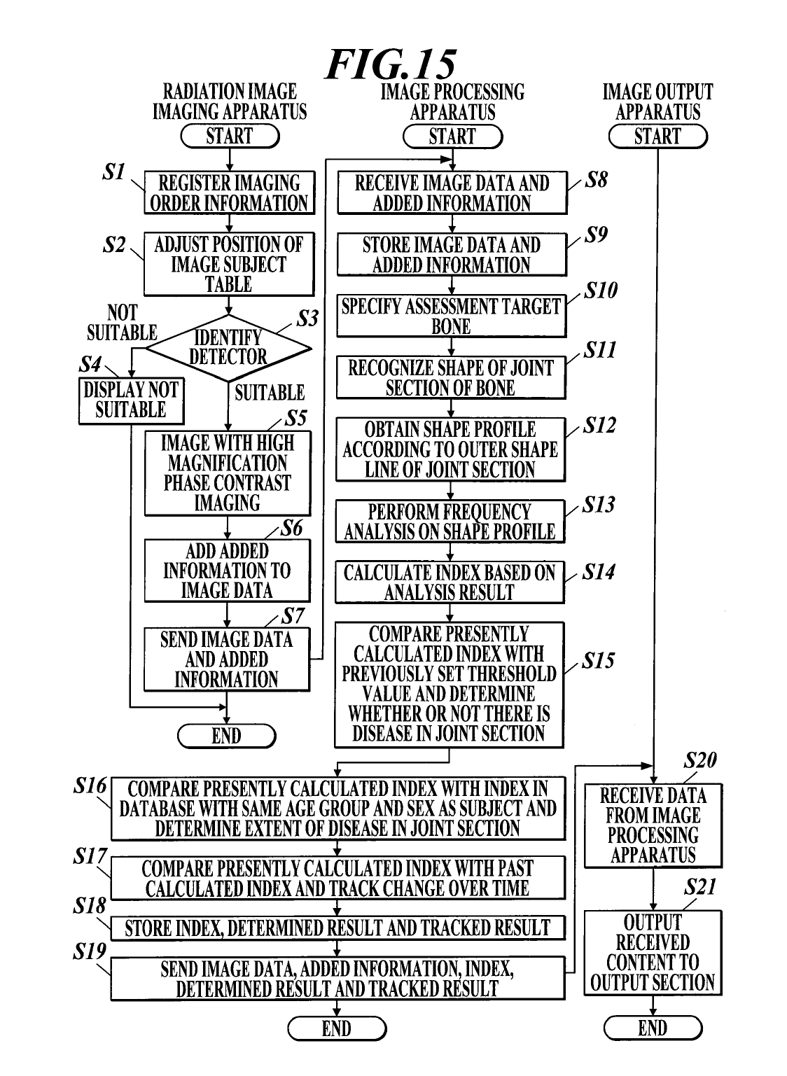

The index calculating section 38 calculates an index concerning the disease of the joint section based on the analysis result of the frequency analyzing section 39. Specifically, for example as shown in FIG. 14, the index calculating section 38 integrates the analysis result Q1 of the frequency analyzing section 39 in the area within spatial frequency 3 to 5 cycle/mm in full scale size of the image subject and calculates the integral value as the index concerning the disease of the joint section. The area of spatial frequency 3 to 5 cycle/mm in full scale size of the image subject is set within the location (above described oval Q) where the difference between a bone disease patient and a healthy subject is expressed easily.

Then, the index calculating section 38 compares the calculated index presently calculated by the index calculating section 38 with the threshold value previously set in the storage section 32 to determine whether or not the disease occurred in the joint section of the bone.

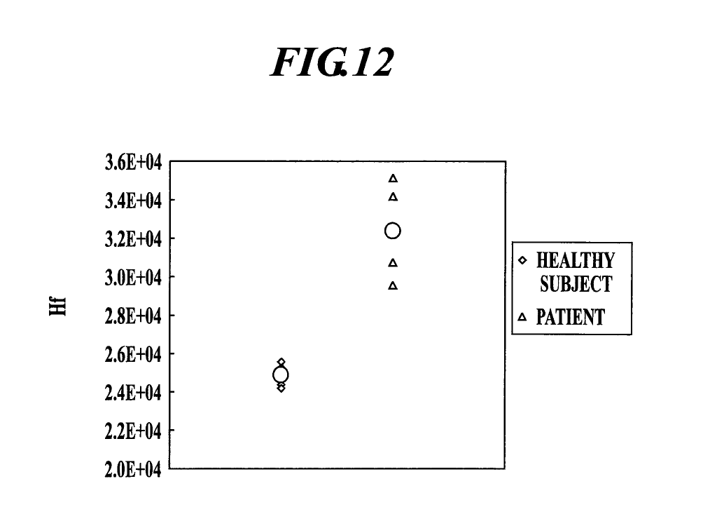

For example, FIG. 12 is a diagram comparing the calculated index (above described integral value Hf) of five healthy subjects and five bone disease patients. Incidentally, the circle in the figure is the average value of the five people. As shown in FIG. 12, the average value of the calculated index of healthy subjects is about 25000, whereas the average value of the calculated index of patients is about 32500. Therefore, in the present embodiment, for example, 30000 is stored in the storage section 32 as a threshold value, and the index calculating section 38 compares the calculated index presently calculated with the threshold value previously stored in the storage section 32 to evaluate whether or not there is a disease in the interest area R of the evaluation target bone B1.

Incidentally, the threshold value is calculated by experiment, simulation, analysis of past data, etc. so that the initial symptom of bone disease can be determined with the value.

Also, the index calculating section 38 compares the calculated index presently calculated by the index calculating section 38 with the index in the database in the storage section 32 with the same age group and sex as the subject who is the object of the calculated index and by taking into account the difference in the extent of the disease according to difference in age group or sex, the index calculating section 38 determines the extent of the disease of the joint section of the bone.

Further, the index calculating section 38 compares the calculated index presently calculated by the index calculating section 38 with the past calculated index stored in the storage section 32 to track the change of the disease over time in the same patient.

Then, according to the above described determined result and tracked result of the index calculating section 38, the control section 31 allows the display section of the later described image output apparatus 50 to display according to the result or allows film output according to the result.

The image processing section 35 performs image processing on the image data of the radiation image such as gradation processing to adjust contrast of the image, processing to adjust density, frequency processing to adjust sharpness, and the like. With this, image processing suitable to the condition of the imaged site, etc. can be performed.

Incidentally, it is preferable that the image processing parameter which specifies the image processing condition corresponding to the conditions such as imaged site, image condition, image direction etc. is previously stored in the storage section 32 etc., and it is preferable that when the image processing is performed, the image processing section 35 reads out the image processing parameter corresponding to the information added to the image data such as which site of the body the radiation image imaged, imaged site, imaged direction, etc. from the storage section 32 and determines the image processing condition based on the read out parameter. Incidentally, when information such as the site imaged in the image data, imaged direction, etc. are not added to the image data, necessary condition is input from the input section 33, etc. and image processing can be performed based on the input condition.

Next, the image output apparatus 50 is an image display apparatus, printer, etc. including, for example, an output section including a monitor (display section) such as CRT (Cathode Ray Tube), LCD (Liquid Crystal Display), etc., print section for printing (film output) image data on a medium such as film, paper, etc., or the like, communication section to connect to external devices, power source section for supplying power source, (all not shown) and the like. When the control section 31 determines whether or not there is a change in each section between the target image and the past image or whether or not there is a changed portion (changed area), the image output apparatus 50 functions as an output section to output the determined result. The communication section includes a network interface etc., and sends and receives data to and from the radiation image imaging apparatus 1 and the external devices such as image output apparatus 50, etc. connected to the network N through the switching hub.

In the image output apparatus 50, when the communication section 34 receives through the network N image data of the radiation image subjected to image processing performed by the image processing apparatus 30, the image is suitably output from the output section (display section or print section).

Also, as described above, when the display content is determined by the image processing apparatus 30, for example, the content is displayed on the display section of the image output apparatus 50 or the content is clearly shown on the film output.

Incidentally, when the image output apparatus 50 is an image display apparatus including a monitor (display section), it is preferable that a monitor (display section) with higher definition than that of a general PC (Personal Computer), etc. is included, because a medical image for diagnosis is displayed to be presented for diagnosis by a doctor, etc.

Next, the operation of the bone disease evaluating system 100 of the present embodiment is described with reference to FIG. 15.

First, when the imaged subject (patient) performs an examination registration (image order registration) with an examination reception, etc. which is not shown, and the image order information is registered, based on the image order information, either the left or the right arm section of the imaged subject is placed on the image subject table 14 and the triangular magnet 17 is placed between the thumb and the index finger (step S1).

Then, the adjustment of the position of the image subject table 14 and the adjustment of the angle of the imaging apparatus main body section 4 is performed by the driving device 6 and the position adjusting device 15 according to the image condition such as radiation irradiation angle, irradiation distance, imaging magnification, etc. In the present embodiment, the position of the image subject table 14 is adjusted for phase contrast imaging (step S2).

Then, in step S3, when the detector 11 identified by the detector identifying section 29 does not match the suitable detector set in step S2, in other words, it is not suitable, the control device 22 advances to step S4 and when it is identified to be for phase contrast imagining, the control device 22 advances to step S5.

In step S4, the control device 22 controls the display device 24b to display the set detector 11 is not suitable for the present imaging and ends the operation.

In step S5, after the above described adjustment of the position and the angle of the image subject table 14, the power source section 9 applies tube voltage to the X-ray source 8 so that the average radiation energy is 26 keV and the X-ray source 8 irradiates irradiation to the image subject H to perform phase contrast imaging.

When image data of the phase contrast image is generated, image direction information, left and right information, imaged subject information, imaged time information, site information, etc. are added to each piece of generated image data as added information (step S6). Then, the radiation image imaging apparatus 1 sends the generated image data of the radiation image with the added information to the image processing apparatus 30 (step S7).

When the image processing apparatus 30 receives the image data and the added information from the radiation image imaging apparatus 1 (step S8), the image processing apparatus 30 stores the received image data and the added information in the storage section 32 (step S9).

The control section 31 specifies the bone specified with the input section 33 as the evaluation target bone B1 (step S10).

Then, the control section 31 controls the joint recognizing section 37 to recognize the shape of the joint section of the evaluation target bone B1 in the image data (step S11).

Then, the control section 31 controls the profile obtaining section 40 and obtains the shape profile based on the outer shape line of the joint section of the evaluation target bone B1 (step S12).

When the control section 31 obtains the shape profile, the control section 31 controls the frequency analyzing section 39 to perform frequency analysis on the shape profile (step S13).

Then, the control section 31 controls the index calculating section 38 to calculate the index concerning the disease of the joint section based on the analysis result of the frequency analyzing section 39 (step S14).

The control section 31 controls the index calculating section 38 to compare the calculated index presently calculated by the index calculating section 38 with the threshold value previously set in the storage section 32 and to judge whether or not the disease occurred in the joint section of the bone (step S15).

Next, the control section 31 controls the index calculating section 38 to compare the calculated index presently calculated by the index calculating section 38 with the index of the database in the storage section 32 which is the same age group and sex as the subject who is the object of the calculated index and determines the extent of the disease of the joint section of the bone taking into account the difference in the extent of the disease according to difference in age group and sex (step S16).

Then, the control section 31 controls the index calculating section 38 to compare the calculated index presently calculated by the index calculating section 38 with the past calculated index stored in the storage section 32 and tracks the change of the disease over time in the same patient (step S17).

Then, the control section 31 controls the storage section 32 to store the index presently calculated, the determined result and the tracked result (step S18).

Then, in step S19, the control section 31 sends through the communication section 34 to the image output apparatus 50 image data sent from the radiation image imaging apparatus 1, added information, present calculated index, determined result, tracked result, and past calculated index when there is a past calculated index.

When the image output apparatus 50 receives data from the image processing apparatus 30 (step S20), the image output apparatus 50 outputs the received content to the output section (step S21). As an output method, as described above, any one of a viewer display by a monitor (display section) or film output (hard copy) by a print section can be performed. With this, comparison display based on image data, added information, present calculated index, determined result and tracked result, and past calculated index can be viewed on the image output apparatus 50. Here, comparison display of the present calculated index and the past calculated index and comparison display of present calculated index and evaluation standard value can be performed on the image output apparatus 50.

As described above, according to the bone disease evaluating system 100 of the present embodiment, with a phase contrast image with higher sharpness than an absorption contrast image, the shape profile representing the change in shape of the joint section of the bone can be obtained, and the shape profile of the disease such as bone erosion or bone spur is better reflected. Also, by performing frequency analysis on the shape profile the extent of the disease such as bone erosion and bone spur clearly appears in the analysis result. When an index concerning the disease of the joint section is calculated according to the analysis result of the frequency analyzing section, the above described disease can be diagnosed quantitatively. With this, accuracy of quantitative diagnosis of disease can be enhanced than conventional methods.

Incidentally, in the present embodiment, an example where the image processing apparatus 30 and the image output apparatus 50 are provided as different apparatuses is described, however, one apparatus can function as both the image processing apparatus 30 and the image output apparatus 50.

Also, in the present embodiment, an example where image analysis is performed on one image of bone or joint is shown, however, image analysis can be performed on a plurality of images of bone or joint and the image analysis results can be stored or displayed or image analysis can be performed on a plurality of images of bone or joint and a result of summary processing of the image analysis results can be stored or displayed.

### INDUSTRIAL APPLICABILITY

The present invention can be applied to the field which performs radiation image imaging (and in particular the field of medicine).

1. A bone disease evaluating system comprising:
a radiation source to emit radiation;
a detector to detect a phase contrast image of the radiation emitted from the radiation source to an image subject including a bone and transmitted through the bone;
a joint recognizing section to recognize a joint section of the bone from the phase contrast image;
a profile obtaining section to obtain a shape profile showing a change in shape of the joint section from the joint section of the bone recognized by the joint recognizing section;
a frequency analyzing section to perform frequency analysis on the shape profile obtained by the profile obtaining section; and
an index calculating section to calculate an index concerning a disease of the joint section based on the analysis result of the frequency analyzing section.

2. The bone disease evaluating system of claim 1, wherein the index calculating section compares the calculated index presently calculated in the index calculating section with a previously set threshold value.

3. The bone disease evaluating system of claim 1, further comprising:
a calculated index storage section to store the calculated index calculated by the index calculating section, wherein
the index calculating section compares the calculated index presently calculated by the index calculating section with a past calculated index stored in the calculated index storage section.

4. The bone disease evaluating system of claim 1, further comprising:
a healthy subject database storage section to compile and store a database of an index of healthy subject of each age group and sex based on an analysis result of frequency analysis on a plurality of healthy subjects of different age group and sex, wherein
the index calculating section compares the calculated index presently calculated by the index calculating section with the index in the database of the database storage section with a same age group and sex as a subject who is the object of the calculated index.

5. The bone disease evaluating system of claim 1, wherein the index calculating section calculates an integral value of an analysis result of the frequency analyzing section within a previously set frequency range as the index.

6. The bone disease evaluating system of claim 2, further comprising:
a calculated index storage section to store the calculated index calculated by the index calculating section, wherein
the index calculating section compares the calculated index presently calculated by the index calculating section with a past calculated index stored in the calculated index storage section.

7. The bone disease evaluating system of claim 6, further comprising:
a healthy subject database storage section to compile and store a database of an index of healthy subject of each age group and sex based on an analysis result of frequency analysis on a plurality of healthy subjects of different age group and sex, wherein
the index calculating section compares the calculated index presently calculated by the index calculating section with the index in the database of the database storage section with a same age group and sex as a subject who is the object of the calculated index.

8. The bone disease evaluating system of claim 2, further comprising:
a healthy subject database storage section to compile and store a database of an index of healthy subject of each age group and sex based on an analysis result of frequency analysis on a plurality of healthy subjects of different age group and sex, wherein
the index calculating section compares the calculated index presently calculated by the index calculating section with the index in the database of the database storage section with a same age group and sex as a subject who is the object of the calculated index.

9. The bone disease evaluating system of claim 3, further comprising:
a healthy subject database storage section to compile and store a database of an index of healthy subject of each age group and sex based on an analysis result of frequency analysis on a plurality of healthy subjects of different age group and sex, wherein
the index calculating section compares the calculated index presently calculated by the index calculating section with the index in the database of the database storage section with a same age group and sex as a subject who is the object of the calculated index.

10. The bone disease evaluating system of claim 9, wherein the index calculating section calculates an integral value of an analysis result of the frequency analyzing section within a previously set frequency range as the index.

11. The bone disease evaluating system of claim 2, wherein the index calculating section calculates an integral value of an analysis result of the frequency analyzing section within a previously set frequency range as the index.

12. The bone disease evaluating system of claim 3, wherein the index calculating section calculates an integral value of an analysis result of the frequency analyzing section within a previously set frequency range as the index.

13. The bone disease evaluating system of claim 4, wherein the index calculating section calculates an integral value of an analysis result of the frequency analyzing section within a previously set frequency range as the index.

14. The bone disease evaluating system of claim 6, wherein the index calculating section calculates an integral value of an analysis result of the frequency analyzing section within a previously set frequency range as the index.

15. The bone disease evaluating system of claim 7, wherein the index calculating section calculates an integral value of an analysis result of the frequency analyzing section within a previously set frequency range as the index.

16. The bone disease evaluating system of claim 8, wherein the index calculating section calculates an integral value of an analysis result of the frequency analyzing section within a previously set frequency range as the index.

17. The bone disease evaluating system of claim 9, wherein the index calculating section calculates an integral value of an analysis result of the frequency analyzing section within a previously set frequency range as the index.
